(19) United States
(12) Patent Application Publication
(10) Pub. No.: US 2006/0176513 A1
(43) Pub. Date: Aug. 10, 2006

(54) Printer, printer control method, and recording medium

(76) Inventor: Daisuke Yamashita, Kanagawa (JP)

Correspondence Address: HARNESS, DICKEY & PIERCE, P.L.C., P.O. BOX 8910, RESTON, VA, 20195, US

(21) Appl. No.: 11/331,352

(22) Filed: Jan. 13, 2006

(30) Foreign Application Priority Data
Jan. 14, 2005 (JP) 2005-007521

(51) Int. Cl. G06F 3/12

(52) U.S. Cl. 358/1.15

(57) ABSTRACT

A printer supporting direct printing is disclosed that includes an obtaining part configured to obtain images from an external image feeder and a notification part configured to notify the external image feeder of completion of processing the images obtained by the obtaining part. The obtaining part is capable of obtaining an (N+1)^{th} one of the images before the notification part notifies the external image feeder of completion of processing an one of the images, N being a natural number.

### BACKGROUND OF THE INVENTION

1. Field of the Invention

The present invention generally relates to printers, printer control methods, and recording media, and more particularly to a printer supporting direct printing or PictBridge, a method of controlling such a printer, and a computer-readable recording medium on which a program for causing a computer to execute such a method is recorded.

2. Description of the Related Art

In recent years, it has been made possible to output an image captured and stored by a digital still camera (DSC) from a printer without using a personal computer (PC) by connecting the DSC and the printer directly without intervention of the PC. This function is called “direct printing.” In order to realize this function, CIPA (Camera & Imaging Products Association) has published PictBridge (a CIPA standard “CIPA DC-001-2003 Digital Photo Solutions for Imaging Devices”) as a standard to be used for communications between the DSC and the printer.

Apparatuses that can support PictBridge are not limited to the above-described DSC and printer.

For example, the technique disclosed in Japanese Laid-Open Patent Application No. 2002-94910 is known as relating to this direct printing.

In the conventional DSC and printer supporting direct printing, the following operations are performed in order in the case where the printer prints out an image in accordance with a request from the DSC side.

Receive a print request (Startjob command) from the DSC, and store an image name specified in the print request.

Obtain the image data of a single image from the DSC.

Convert the obtained image data into data of a format usable for printing.

Perform printing based on the converted data.

Transmit a printing progress notice to the DSC when printing of the image ends.

Repeat the above-described operations (b) through (e) if there is a subsequent image.

Transmit a printing end notice to the DSC if there is no subsequent image.

Thus, in the case of performing printing in accordance with a request from the DSC, the conventional printer obtains the image data of a single image, performs data format conversion after obtaining the image data, and performs printing after completion of the conversion. Then, after completion of printing of the single image, the conventional printer starts to obtain data on the next image. Accordingly, printing takes a long time from start to finish.

Further, the time required for each operation differs depending on the printer, the DSC, the performance of the communication path therebetween, image size, print quality, or printing means. Nowadays, images are becoming higher in quality, and image files are becoming larger in size. This trend has an effect of increasing the time required for processing. Further, there is a users' demand for high-speed printing of these images of high quality and large size.

In particular, in the case of direct printing, there is a problem in that an apparatus on the image feeding side, such as a DSC, is bound (committed) to a printing (image feeding) operation until receiving a printing end notice from a printer after transmitting a print request to the printer, and cannot perform other operations during that period. Accordingly, along with the demand for high-speed printing, there is also a demand for reduction in time for which the apparatus on the image feeding side is bound to an image feeding operation.

### SUMMARY OF THE INVENTION

Accordingly, it is a general object of the present invention to provide a printer, a method of controlling the same, and a computer-readable recording medium on which is recorded a program for causing a computer to execute such a method.

A more specific object of the present invention is to provide a printer in which time for which an image-feeding-side apparatus is bound to an operation in printing by direct printing is reduced.

Another more specific object of the present invention is to provide a method of controlling the printer and a computer-readable recording medium on which is recorded a program for causing a computer to execute such a method.

One or more of the above objects of the present invention are achieved by a printer supporting direct printing, including: an obtaining part configured to obtain images from an external image feeder; and a notification part configured to notify the external image feeder of completion of processing the images obtained by the obtaining part, wherein the obtaining part is capable of obtaining an (N+1)^{th} one of the images before the notification part notifies the external image feeder of completion of processing an N^{th} one of the images, N being a natural number.

One or more of the above objects of the present invention are also achieved by a printer supporting direct printing, including: an obtaining part configured to obtain images from an external image feeder; and a notification part configured to notify the external image feeder of completion of processing pages including the images obtained by the obtaining part, wherein the obtaining part is capable of obtaining at least one of the images corresponding to an (N+1)^{th} one of the pages before the notification part notifies the external image feeder of completion of processing an one of the pages, N being a natural number.

One or more of the above objects of the present invention are also achieved by a printer supporting direct printing, including a notification part configured to notify a feeder of an image to be printed of completion of printing all pages, wherein the notification part is capable of notifying the feeder of the completion of printing all the pages before the completion of printing all the pages.

One or more of the above objects of the present invention are also achieved by a printer supporting direct printing, including a notification part configured to notify a feeder of obtained images of progress of printing with respect to the images or a page including at least two of the images, wherein the notification part is capable of notifying the feeder of completion of printing with respect to one of the images or the page before completion of printing the one of the images or the page.

One or more of the above objects of the present invention are also achieved by a printer supporting direct printing, including: an obtaining part configured to obtain images from an external image feeder and store image data of the images in a buffer; and a processing part configured to process the image data stored in the buffer, wherein the obtaining part is capable of obtaining the image data of an (N+1)^{th} one of the images before the processing part finishes processing the image data of an N^{th} one of the images after the obtaining part stores the image data of the N^{th} one of the images in the buffer, N being a natural number.

One or more of the above objects of the present invention are also achieved by a printer supporting direct printing, including: a processing part configured to process image data stored in a first buffer and store the processed image data in a second buffer; and a print part configured to print images based on the image data stored in the second buffer, wherein the processing part is capable of processing the image data of an (N+1)^{th} one of the images before the print part finishes printing with respect to an N^{th} one of the images after the processing part stores the processed image data in the second buffer with respect to the N^{th} one of the images, N being a natural number.

One or more of the above objects of the present invention are also achieved by a printer supporting PictBridge, including: a first part to transmit a GetPartialObject command to an external image feeder; and a second part to transmit a NotifyjobStatus command to the external image feeder, wherein an (N+1)^{th} image is obtainable by transmitting the GetPartialObject command to the external image feeder before transmitting the NotifyJobStatus command indicating completion of processing an N^{th} image, N being a natural number.

One or more of the above objects of the present invention are also achieved by a printer supporting PictBridge, including: a first part to transmit a GetPartialObject command to an external image feeder; and a second part to transmit a NotifyJobStatus command to the external image feeder, wherein an image of an (N+1)^{th} page is obtainable by transmitting the GetPartialObject command to the external image feeder before transmitting the NotifyJobStatus command indicating completion of processing an N^{th} page, N being a natural number.

One or more of the above objects of the present invention are also achieved by a printer supporting PictBridge, including a part to transmit a NotifyDeviceStatus command to a feeder of an image to be printed, wherein the NotifyDeviceStatus command is transmittable before completion of printing all pages.

One or more of the above objects of the present invention are also achieved by a printer supporting PictBridge, including a part to transmit a NotifyJobStatus command to a feeder of images to be printed, wherein the NotifyJobStatus command indicating completion of printing one of the images or a page is transmittable before the completion of printing the one of the images or the page.

One or more of the above objects of the present invention are also achieved by a method of controlling a printer supporting direct printing, the method including the steps of: (a) causing the printer to obtain images from an external image feeder; and (b) causing the printer to notify the external image feeder of completion of processing the obtained images, wherein the printer is caused to obtain an (N+1)^{th} one of the images before the printer is caused to notify the external image feeder of completion of processing an N^{th} one of the images, N being a natural number.

One or more of the above objects of the present invention are also achieved by a method of controlling a printer supporting direct printing, the method including the steps of: (a) causing the printer to obtain images from an external image feeder; and (b) causing the printer to notify the external image feeder of completion of processing pages including the images, wherein the printer is caused to obtain at least one of the images corresponding to an (N+1)^{th} one of the pages before the printer is caused to notify the external image feeder of completion of processing an N^{th} one of the pages, N being a natural number.

One or more of the above objects of the present invention are also achieved by a method of controlling a printer supporting direct printing, the method including the step of causing the printer to notify a feeder of an image to be printed of completion of printing all pages, wherein the printer is caused to notify the feeder of the completion of printing all the pages before the completion of printing all the pages.

One or more of the above objects of the present invention are also achieved by a method of controlling a printer supporting direct printing, the method including the steps of: (a) causing the printer to notify a feeder of obtained images of progress of printing with respect to the images or a page including at least two of the images; and (b) causing the printer to notify the feeder of completion of printing with respect to one of the images or the page before completion of printing the one of the images or the page.

One or more of the above objects of the present invention are also achieved by a computer-readable recording medium on which is recorded a program for causing a computer controlling a printer to execute a printer control method, the method including the steps of: (a) obtaining images from an external image feeder; (b) notifying the external image feeder of completion of processing the obtained images; and (c) causing the printer to perform printing by direct printing, wherein step (a) obtains an (N+1)^{th} one of the images before step (b) notifies the external image feeder of completion of processing an N^{th} one of the images, N being a natural number.

One or more of the above objects of the present invention are also achieved by a computer-readable recording medium on which is recorded a program for causing a computer controlling a printer to execute a printer control method, the method including the steps of: (a) obtaining images from an external image feeder; (b) notifying the external image feeder of completion of processing pages including the obtained images; and (c) causing the printer to perform printing by direct printing, wherein step (a) obtains at least one of the images corresponding to an (N+1)^{th} one of the pages before step (b) notifies the external image feeder of completion of processing an N^{th} one of the pages, N being a natural number.

One or more of the above objects of the present invention are also achieved by a computer-readable recording medium on which is recorded a program for causing a computer controlling a printer to execute a printer control method, the method including the steps of: (a) causing the printer to perform printing by direct printing; and (b) notifying a feeder of an image to be printed of completion of printing all pages, wherein step (b) notifies the feeder of the completion of printing all the pages before the completion of printing all the pages.

One or more of the above objects of the present invention are also achieved by a computer-readable recording medium on which is recorded a program for causing a computer controlling a printer to execute a printer control method, the method including the steps of: (a) causing the printer to perform printing by direct printing; (b) notifying a feeder of obtained images of progress of the printing with respect to the images or a page including at least two of the images; and (c) notifying the feeder of completion of printing with respect to one of the images or the page before completion of printing the one of the images or the page.

According to a printer and a method of controlling the printer according to one embodiment of the present invention, it is possible to reduce time for which an apparatus on the image feeding side is bound to processing at the time of performing printing by direct printing.

Further, according to a computer-readable recording medium according to one embodiment of the present invention, it is possible to produce the above-described effect by causing a computer to read out a program for causing the computer to execute the method of controlling the printer, and by causing the computer to execute the program.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a configuration of a printer according to an embodiment of the present invention;

FIG. 2 is a block diagram showing a connected state of the printer of FIG. 1 and an external DSC according to the embodiment of the present invention;

FIGS. 3A and 3B are diagrams showing an operational sequence in the case where a conventional printer supporting PictBridge and direct printing performs direct printing at the request of the DSC supporting PictBridge;

FIG. 4 is a block diagram showing a functional configuration of the printer shown in FIG. 1 according to the embodiment of the present invention;

FIG. 5 is a diagram showing an operational sequence in the case where the printer shown in FIG. 1 prints one page formed of a single image by direct printing at the request of the DSC supporting PictBridge according to the embodiment of the present invention;

FIGS. 6A and 6B are diagrams showing an operational sequence in the case where the printer shown in FIG. 1 prints one page formed of two images by direct printing at the request of the DSC supporting PictBridge according to the embodiment of the present invention;

FIGS. 7A and 7B are diagrams showing an operational sequence in the case where the printer shown in FIG. 1 prints two pages each formed of a, single image by direct printing at the request of the DSC supporting PictBridge according to the embodiment of the present invention;

FIG. 8 is a flowchart showing one of operations executed by a CPU of the printer shown in FIG. 1 which one relates to a communications control module according to the embodiment of the present invention;

FIG. 9 is a flowchart showing another one of the operations executed by the CPU of the printer shown in FIG. 1 which one relates to the communications control module according to the embodiment of the present invention;

FIG. 10 is a flowchart showing one of the operations executed by the CPU of the printer shown in FIG. 1 which one relates to an image processing module according to the embodiment of the present invention; and

FIG. 11 is a flowchart showing one of the operations executed by the CPU of the printer shown in FIG. 1 which one relates to an image rendering module according to the embodiment of the present invention.

### DETAILED DESCRIPTION OF THE PREFERRED EMBODIMENTS

A description is given, with reference to the accompanying drawings, of an embodiment of the present invention.

[Hardware Configuration]

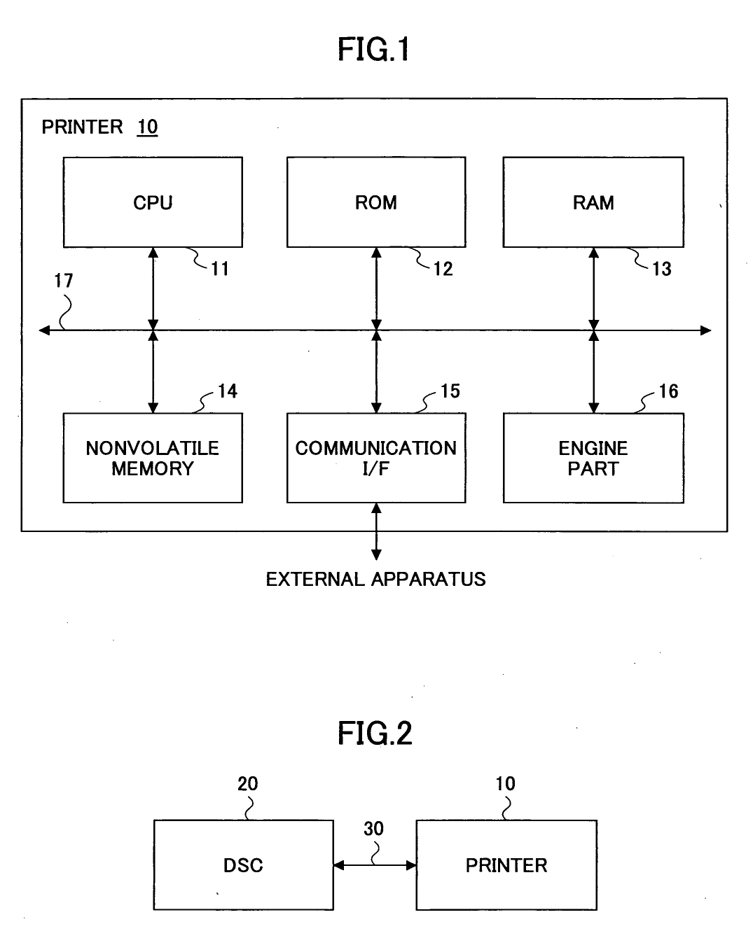

First, a description is given, with reference to FIGS. 1 and 2, of a printer hardware configuration according to the embodiment of the present invention.

FIG. 1 is a block diagram showing a configuration of a printer 10 according to the embodiment of the present invention.

Referring to FIG. 1, the printer 10 includes a CPU 11, a ROM 12, a RAM 13, a nonvolatile memory 14, a communication interface (I/F) 15, and an engine part 16, which are connected via a system bus 17.

The CPU 11 is a control part to perform centralized control of the entire printer 10. By executing various programs stored in the ROM 12 and the nonvolatile memory 14, the CPU 11 functions as various parts including an obtaining part, a notification part, a processing part, and a print part, thereby realizing a variety of functions relating to features of this embodiment as described below.

The ROM 12, which is a nonvolatile storage part, stores programs executed by the CPU 11 and static parameters. The ROM 12 may be configured as a rewritable storage part so that these data can be updated.

The RAM 13 is a storage part to store data for temporary use. The RAM 13 is also used as a work memory for the CPU 11 and as below-described first and second buffers.

The nonvolatile memory 14, which is a rewritable nonvolatile storage part formed of an NVRAM (nonvolatile RAM) or an HDD (hard disk drive), stores programs executed by the CPU 11 and parameter values that should be retained even after the apparatus (printer 10) is turned off.

The communication I/F 15 is an interface for connecting the printer 10 to an external apparatus. The communication I/F 15 may be, for example, a USB (universal serial bus) interface for performing USB communications or an IEEE 1394 (Institute of Electrical and Electronics Engineers 1394) interface for performing IEEE 1394 communications. As the communication I/F 15, various types of interfaces other than those described above may also be used irrespective of whether they are wired or wireless. An interface to be connected to a LAN (local area network) so as to enable network communications may also be used.

The engine part 16 is an image forming part to form an image on paper by electrophotography. Appropriate control of the operation of the engine part 16 by the CPU 11 enables the printer 10 to perform a print operation. The configuration of the engine part 16 is graphically represented in a simplified manner.

The printer 10 supports direct printing. As shown in FIG. 2, the printer 10 is connected to an external digital still camera (DSC) 20, which is an image feeder, without intervention of a PC, so that the printer 10 can obtain image data from the DSC 20 and form an image on paper based on the image data.

In this case, communications are performed through the communication I/F 15. A communication path 30 between the printer 10 and the DSC 20 may be either a wired one such as a USB cable, an IEEE 1394 cable, or a LAN cable, or a wireless one such as infrared communication or a wireless LAN. Further, the communication path 30 may be one for one-to-one communications or for network communications. Further, a communication I/F on the DSC 20 side and the communication I/F 15 on the printer 10 side may be connected directly without intervention of a cable.

A block diagram of the hardware configuration of the DSC 20 is substantially the same as that of the printer 10 shown in FIG. 1. Actually, the printer 10 and the DSC 20 have substantial differences in appearance and configuration. However, those differences appear in the details of the engine parts and the exteriors not graphically illustrated. The CPUs, ROMs, and RAMs employed in the printer 10 and the DSC 20 may be the same although they may be different in capacity and processing capability.

Further, the printer 10 corresponds to an image output device in PictBridge. In the case of direct printing, the printer 10 can perform a print operation, exchanging commands and data appropriately with the DSC 20 having the function of performing PictBridge-compliant communications. The DSC 20 corresponds to an image source device in PictBridge. In this sense, the printer 10 supports PictBridge. The image feeder to request the printer 10 to perform printing by direct printing is not limited to the DSC 20 as long as the image feeder is capable of PictBridge-compliant communications. For example, the image feeder may be a unit formed by adding a microcomputer for communications and a simple operator for image feeding instructions to a flash memory storing image data.

[Operation of Comparative Example]

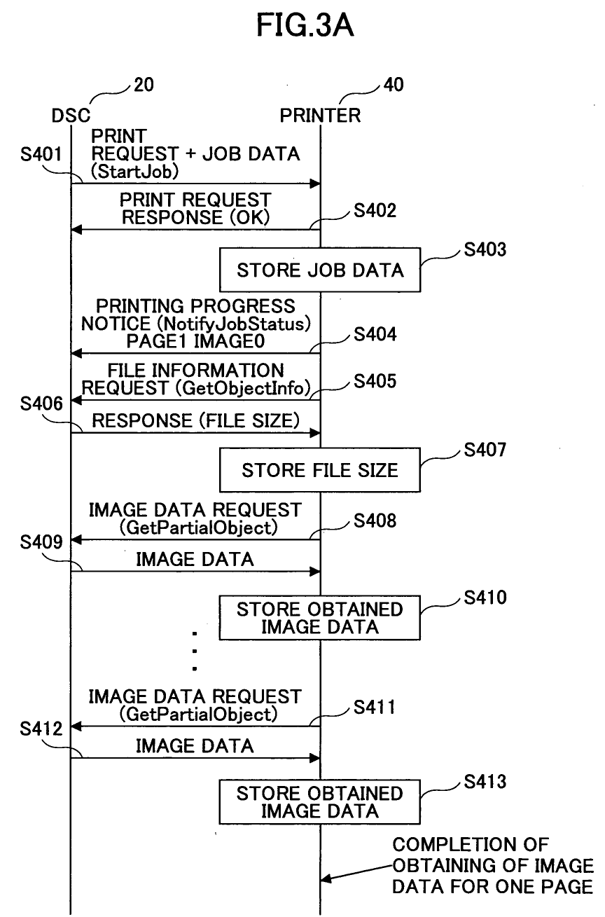

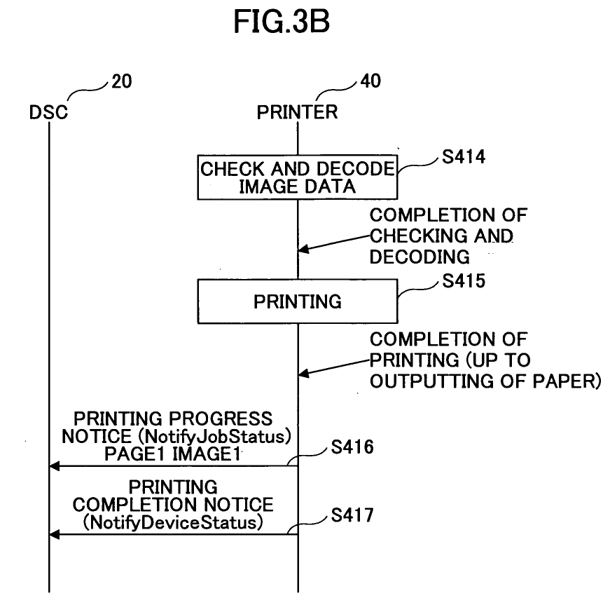

Here, an operational sequence in the case where a conventional printer 40 supporting PictBridge and direct printing performs direct printing at the request of the DSC 20 supporting PictBridge is shown in FIGS. 3A and 3B as a comparative example.

In PictBridge-compliant communications, when an image-feeding-side apparatus requests a printer to perform printing for the first time, a procedure of negotiation (a procedure of Discovery, Configure, and GetCapability) to confirm each other's compliance with PictBridge and to check each other's functions is performed. However, this procedure does not have much to do with features of this embodiment. Accordingly, a description and graphical illustration thereof are omitted in this comparative example as well as the below-described operation according to this embodiment.

In this example, when a user connects the DSC 20 and the printer 40, and operates the DSC 20 to specify one or more images to be printed and give an instruction to execute direct printing, in step S401 of FIG. 3A, the DSC 20 transmits a StartJob command to the printer 40. At this point, the DSC 20 also transmits job data showing the filenames and IDs of the images to be printed and a print format (the number of images per page and print size) together with the StartJob command. This command is positioned as a print request by which the DSC 20 requests the printer 40 to start a direct printing operation.

If the printer 40 is ready to execute direct printing, in step S402, the printer 40 responds to this request by returning OK as a print request response, and in step S403, the printer 40 stores the received job data.

Thereafter, in step S404, the printer 40 transmits a NotifyJobStatus command to the DSC 20. This command is positioned as a printing progress notice showing the progress or status of printing, and “Page1 Image0” is information indicating the progress of printing. Here, “Page1” indicates completion of printing of the first page, and “Image0” indicates that the number of printed images is zero. That is, “PageX” indicates that printing of the X^{th} page is in execution, and “ImageY” indicates that the number of printed images is Y. The NotifyJobStatus command of “Page1 Image0” is a formality command, and is substantially a notice to indicate that a direct-printing-related operation is going to be started.

After step S404, in step S405, the printer 40 specifies the file ID of the first image, and transmits a GetObjectInfo command to the DSC 20. This command is positioned as a file information request to request transfer of information on an image, file corresponding to the specified file ID, such as file size. In step S406, the DSC 20 transmits information on file size corresponding to the transmitted file ID as a response to this request. In step S407, the printer 40 stores the file size information.

Thereafter, in step S408, the printer 40 transmits a GetPartialObject command to the DSC 20. This command is positioned as an image data request to request the DSC 20 to transfer the image data of an image to be printed. The printer 40 specifies an image file ID and the size and offset value (initially 0) of data to be collected, and transmits the command. In step S409, in response to this command, the DSC 20 transmits to the printer 40 image data of the specified size from the offset position of the image file specified by the offset value. This transmission may be divided and performed in several times. In step S410, the printer 40 receives the image data and stores the received image data in a predetermined memory.

In step S411 through S413, the same operations as steps S408 through S410 are repeated while shifting the offset value at the time of transmitting the GetPartialObject command by the size of the obtained image data, until the printer 40 can obtain image data for one page. Since the total size is known by the response in step S406 and the data size to be obtained by a single transmission of the GetPartialObject command is also known, the completion of obtaining of image data for one page can be recognized by the number of commands required and completion of the corresponding transfers. When the image data for one page is obtained, the operation proceeds to step S414 of FIG. 3B, where the printer 40 checks and decodes the obtained image data. Here, it is determined by the checking whether the image data is normal without damage, and the JPEG (Join Photographic Experts Group) data received from the DSC 20 is converted by the decoding into data of a format that can be used to control a print engine, such as bitmap data.

When the checking and the decoding are completed, in step S415, the printer 40 performs printing using the decoded data, thereby forming an image on paper.

After completion of the operation relating to formation of one or more images for one page (in this case, the number of images for one page is one) by the above-described operation, in step S416, the printer 40 transmits a NotifyJobStatus command of “Page1 Image1” to the DSC 20, thereby notifying the DSC 20 of completion of printing of one page (the first page) and a single image.

At this point, if there is another image to be printed, the operations of steps S405 through S416 are repeated. On the other hand, if printing of all the images requested by the StartJob command is completed, in step S417, the printer 40 transmits, a NotifyDeviceStatus command to the DSC 20, and ends the operation. This command is positioned as a printing completion notice to report completion of requested printing (completion of all pages and all images).

Meanwhile, the DSC 20, which transmits file size information in response to the GetObjectInfo command from the printer 40 and transmits image data in response to the GetPartialObject command from the printer 40, enters a command reception wait state after transmitting the StartJob command in step S401, where the DSC 20 waits to receive commands and does not perform operations other than those related to direct printing. However, when receiving the NotifyDeviceStatus command in step S417, the DSC 20 determines that there is no more need to be in the command reception wait state. Accordingly, the DSC 20 stops being in the command reception wait state, and is again enabled to perform other operations such as image capturing.

The conventional printer 40 performs a print operation by direct printing by the above-described procedure. That is, the printer 40 sequentially performs reception, decoding, and printing of image data in sequence, and after completion of these operations, transmits a NotifyJobStatus command for a printed page. The printer 40 starts to obtain image data for the next page further after transmitting the NotifyJobStatus command. Further, the NotifyDeviceStatus command is transmitted after transmission of a NotifyJobStatus command for the last page. Accordingly, the NotifyDeviceStatus command is transmitted after completion of printing with respect to all pages. Therefore, it takes a long time before the DSC 20 receives the NotifyDeviceStatus command after transmitting the StartJob command, which increases time for which the DSC 20 is bound (committed) to a direct printing operation.

[Operation of This Embodiment]

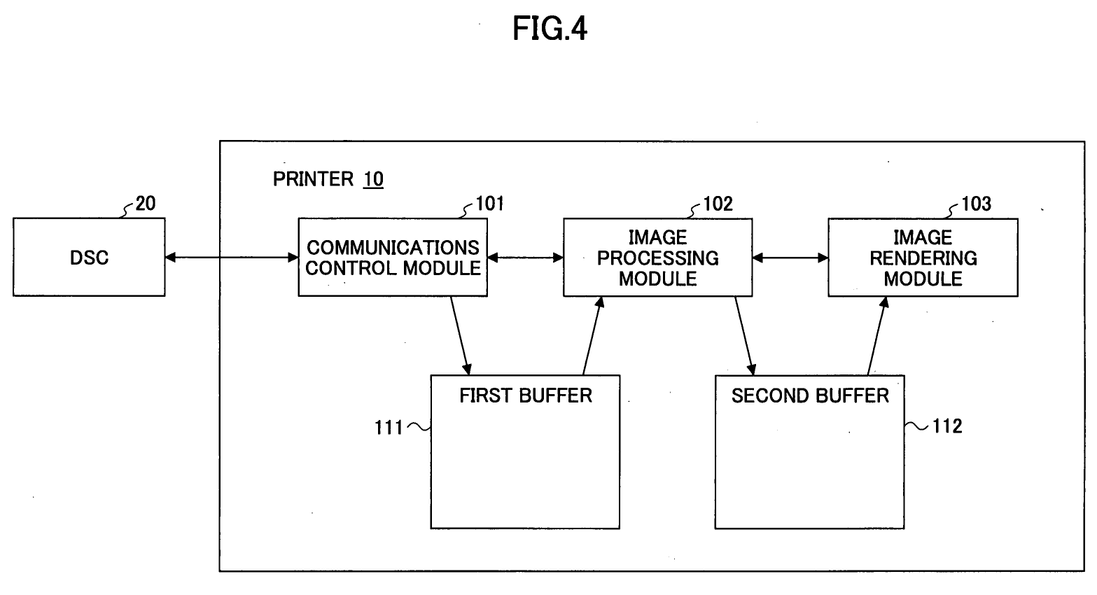

Next, a description is given, with reference to FIGS. 4 through 11, of an operation according to this embodiment.

In the printer 10 according to this embodiment, in executing direct printing, it is possible to obtain an image for the (N+1)^{th} page (where N is a natural number) by transmitting a GetPartialObject command to the DSC 20 before transmitting a NotifyJobStatus command indicating completion of processing of the N^{th} page to the DSC 20. Further, it is possible to transmit the NotifyDeviceStatus command before completion of printing of all pages. Furthermore, it is possible to transmit a NotifyJobStatus command indicating completion of printing of an image or a page before printing of the image or page is completed.

FIG. 4 is a block diagram showing part of the functional configuration of the printer 10 shown in FIG. 1, which part enables the above-described operations.

Referring to FIG. 4, in the printer 10, the functional module for executing direct printing is configured as three independent modules, namely, a communications control module 101, an image processing module 102, and an image rendering module 103. These modules 101 through 103 can execute processing in parallel.

The communications control module 101 has the function of communicating with an image feeder such as the DSC 20, obtaining the image data of an image to be printed from the image feeder, and writing the obtained image data to a first buffer 111. Further, the communications control module 101 also has the function of transmitting various notices to the image feeder. The image processing module 102 has the function of reading out image-data from the first buffer 111, performing the above-described checking and decoding on the read-out image data, and writing the decoded image data to a second buffer 112. The image rendering module 103 has the function of reading out decoded image data from the second buffer 112 and performing printing by driving the engine part 16 based on the read-out decoded image data.

Each of these modules 101 through 103 may be configured as software so as to have its function realized by causing the CPU 11 to execute the software. In this embodiment, this configuration is employed. In the following description, however, the operations that the CPU 11 performs by executing the software relating to these modules 101 through 103 are illustrated as being performed by these modules 101 through 103 for convenience of description.

Further, the first and second buffers 111 and 112 may be provided in, for example, the RAM 13. Further, the first and second buffers 111 and 112 do not have to be provided as separate units, but may be provided in a single memory unit. Further, the address area used as each of the buffers 111 and 112 may be configured to be dynamically variable.

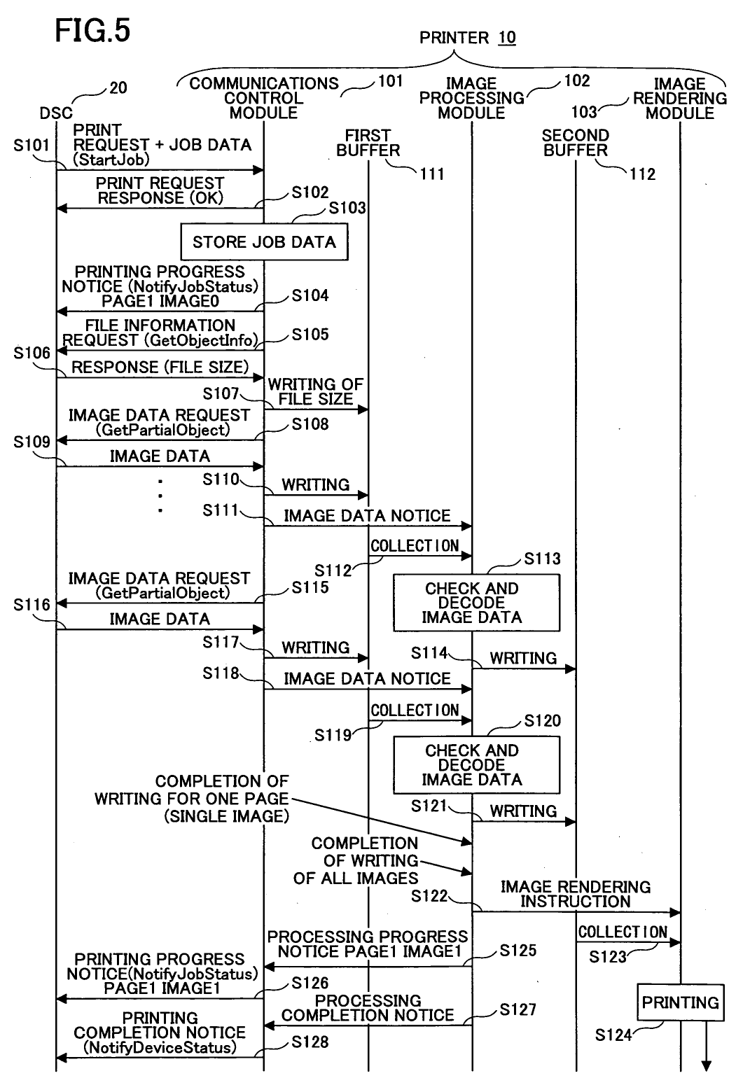

Next, various operational sequences in the case where the printer 10 executes direct printing at the request of the DSC 20 supporting PictBridge are shown in FIGS. 5 through 7B.

First, FIG. 5 shows an operational sequence in the case of printing one page formed of a single image, that is, an operational sequence in the case of performing the same printing as in the comparative example shown in FIGS. 3A and 3B.

In this case, when a user connects the DSC 20 and the printer 10, and operates the DSC 20 to specify one or more images to be printed and give an instruction to execute direct printing, in step S101 of FIG. 5, the DSC 20 transmits a StartJob command and job data to the printer 10 as shown in FIG. 5. On the printer 10 side, the communications control module 101 receives the StartJob command and job data. If the printer 10 is ready to execute direct printing, in step S102, the communications control module 101 responds to this command, and in step S103, stores the job data in a predetermined work area. Further, in step S104, the communications control module 101 transmits the same NotifyJobStatus command of “Page1 Image0” as in step S404 of FIG. 3A to the DSC 20. In the operation of step S103, the job data may also be written to a work area used by the communications control module 101.

After step S104, in step S105, the communications control module 101 transmits a GetObjectInfo command for the first image file to the DSC 20. Then, in step S106, the DSC 20 transmits information on the file size of the image file in response to this command, and the communications control module 101 receives this file size information. In step S107, the communications control module 101 writes the received file size information to the first buffer 111. At this point, the file size information may also be stored separately in the work area.

Either of the transmission of the first NotifyJobStatus command in step S104 and the above-described operations of steps S105, through S107 may be performed first.

Thereafter, in step S108, the communications control module 101 transmits a GetPartialObject command to the DSC 20, specifying the file ID of the first image, a size to be obtained, and an offset in the command. In step S109, the DSC 20 transmits corresponding image data of the specified size in response to this command to the communications control module 101, and the communications control module 101 receives the image data of the specified size. This transmission of the GetPartialObject command and reception of image data correspond to obtaining an image from an image feeder. In this operation, the CPU 11 functions as an obtaining part.

In step S110, the communications control module 101 writes the image data received in step S109 to the first buffer 111, and in step S111, transmits to the image processing module 102 an image data notice indicating that the image data of an image to be printed has been written.

In step S112, receiving this notice, the image processing module 102 collects the image data written to the first buffer 111 by the communications control module 101. In step S113, the image processing module 102 checks and decodes the collected image data. In step S114, the image processing module 102 writes the decoded image data to the second buffer 112. Here, the checking and the decoding are the same as in step S414 of FIG. 3B described above. In the operations of steps S113 and S114, the CPU 11 functions as a processing part.

The operation may include processing such as image layout and paging after the decoding. Further, the checking and decoding may be performed every time the image data notice is received from the communications control module 101. Alternatively, for example, if data written at a time is not suitable in size for the checking and decoding, data of multiple writings may be collectively subjected to the checking and decoding after multiple image data notices are received.

In step S115 through S121, the above-described operations of steps S108 through S114 are repeated while shifting the offset value at the time of transmitting the GetPartialObject command by the size of the obtained image data, until image data for a single image is written to the second buffer 112. No particular management is necessary of the time order between collection of image data from the first buffer 111 by the image processing module 102 and obtaining the next image data by the communications control module 101. The communications control module 101 is prevented from overwriting image data that has not been collected by the image processing module 102 with new image data.

The image processing module 102 can also refer to the file size information written to the first buffer 111 by the communications control module 101. Accordingly, the image processing module 102 can determine, based on the file size information, how many image data notices and corresponding processing iterations can finish processing image data for a single image. Further, in this embodiment, there is only a single image on one page. Accordingly, completion of processing image data for a single image corresponds to completion of processing image data for one page.

When the image processing module 102 detects completion of writing image data for one page to the second buffer 112, in step S122, the image processing module 102 gives an image rendering instruction to instruct the image rendering module 103 to execute printing for one page.

Then, in step S123, the image rendering module 103 collects the decoded image data for one page from the second buffer 112 in response to this instruction. In step S124, the image rendering module 103 performs a print operation to form an image on paper by driving the engine part 16 based on the collected image data. In this operation, the CPU 11 functions as a print part.

On the other hand, when the image processing module 102 detects completion of processing of the image data for a single image, in step S125, the image processing module 102 transmits a processing progress notice to notify the communications control module 101 of the number of the page that is being processed (one in this case) and the number of written images (images that have been written) (one in this case).

Then, in step S126, in response to this notice, the communications control module 101 transmits to the DSC 20 a NotifyJobStatus command to report the page number and the number of images. This command notifies an image source of the progress of printing with respect to an obtained image or a page containing multiple obtained images. In this operation, the CPU 11 functions as a notification part.

In the image processing module 102, no management is necessary of the order between the image rendering instruction of step S122 and the processing progress notice of step S125. In this illustrated case, the former precedes the latter. This order can be reversed without any problem. The image rendering module 103 and the communications control module 101 perform corresponding operations independent of each other in response to the image rendering instruction and the processing progress notice, respectively.

On the other hand, in PictBridge, generally, the NotifyJobStatus command reports the number of printed pages and the number of printed images as described above with respect to step S404 of FIG. 3A and step S416 of FIG. 3B, and the DSC 20 that receives this command interprets the command as having this meaning. Accordingly, the communications control module 101 reports completion of printing with respect to an image or a page to be printed without confirming completion of printing in the image rendering module 103.

Further, when the image processing module 102 detects completion of writing all images to the second buffer 112, in step S127, the image processing module 102 transmits to the communications control module 101 a processing completion notice to indicate completion of writing all images to the second buffer 112. In step S128, in response to this notice, the communications control module 101 transmits a NotifyDeviceStatus command to the DSC 20. In this operation also, the CPU 11 functions as a notification part.

In PictBridge, generally, the NotifyDeviceStatus command reports completion of printing all pages and all images as described above with respect to step S417 of FIG. 3B, and the DSC 20 that receives this command interprets the command as having this meaning. Accordingly, the communications control module 101 also reports completion of printing of all pages without confirming completion of printing in the image rendering module 103.

By causing the printer 10 to operate in this manner, the DSC 20 receives a NotifyDeviceStatus command when processing of image data is completed even if printing in the printer 10 is not completed, and as a result, the DSC 20 is freed from direct printing-related operations. Accordingly, compared with the case of being unable to receive a NotifyDeviceStatus command before completion of printing, it is possible to reduce the time of binding to processing at the time of performing printing by direct printing.

On the other hand, if image data has been decoded and written to the second buffer 112, in most cases, a recovery from failure of a subsequent printing operation can be made with the data stored in the printer 10, so that it is believed that it is seldom required to obtain image data again from the DSC 20. Accordingly, it is believed that reporting completion of printing without confirming it hardly causes any problem.

Further, the NotifyDeviceStatus command should be received at the end of direct-printing-related processing in the DSC 20. Accordingly, the image processing module 102 transmits the processing progress notice of step S125 prior to the processing completion notice of step S127. As a result, the communications control module 101 transmits a NotifyJobStatus command prior to the NotifyDeviceStatus command.

Accordingly, in order to transmit the NotifyDeviceStatus command early, it is important to also transmit the preceding NotifyjobStatus command early. For the communications control module 101 to transmit the NotifyJobStatus command without confirming completion of printing in the image rendering module 103 is also effective in reducing the time of binding.

This processing is possible because the function of performing communications between the printer 10 and the DSC 20, the function of processing a received image, and the function of printing the processed image are realized by respective independent modules whose operations are performable in parallel.

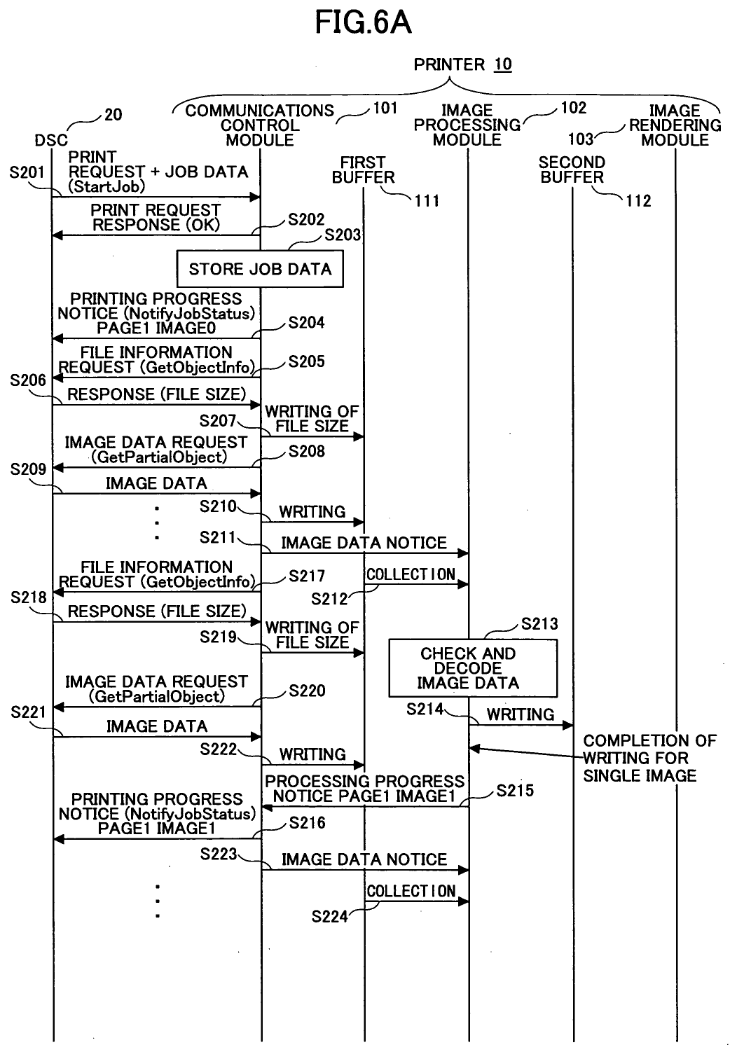

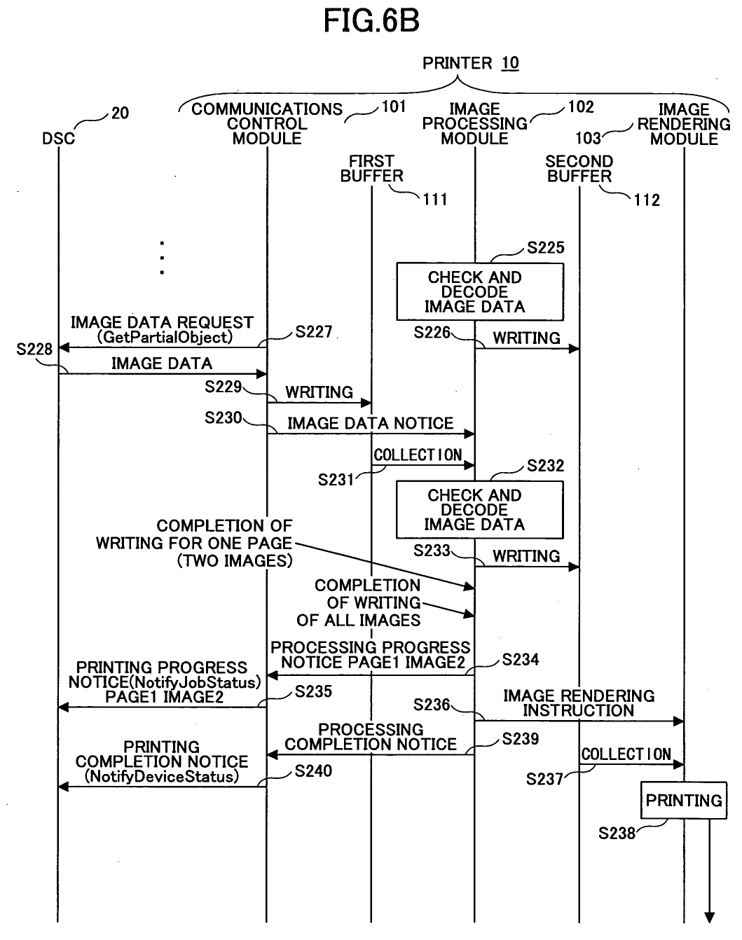

Next, FIGS. 6A and 6B show an operational sequence in the case of printing a page formed of two images. In FIGS. 6A and 6B, a description of the same part as FIG. 5 is simplified or omitted.

In this case, the operation from transmission of a StartJob command in step S201 up to storage of decoded image data by the printer 10 in step S214 is the same as that of steps S101 through S114 of FIG. 5. In this case, however, since writing image data for a single image is completed in step S214, in step S215, the image processing module 102 transmits a processing progress notice to notify the communications control module 101 that the first page is being processed and the number of written images is one. Then, in step S216, in response to this notice, the communications control module 101 transmits to the DSC 20 a NotifyJobStatus command to report the page number and the number of images.

On the other hand, there still remains image data to be obtained from the DSC 20. Accordingly, in steps S217 through S226, the communications control module 101 goes on to transmit a GetPartialObject command to the DSC 20, and obtains image data, while the image processing module 102 processes data newly written to the first buffer 111. Of this operation, the part of steps S225 and S226 is shown in FIG. 6B.

Here, transmission of a GetObjectInfo command and obtaining and writing a file size are performed image file by image file. In the case of obtaining image data relating to a new image (image file), information on the size of the image file is obtained using the ID of the image file, and is written to the first buffer 111 (steps S217 through S219). The ID of an image file of which image data should be obtained next can be recognized from the job data stored in step S203.

In this case, normally, the operations of the communications control module 101 up to transmission of an image data notice (step S223) are usually performed in sequence irrespective of the progress of decoding in the image processing module 102, such as reception of a processing progress notice and transmission of a NotifyJobStatus command. Accordingly, before transmission of a NotifyJobStatus command to the effect that processing is completed with respect to an image, the image data of the next image is obtained. On the other hand, in PictBridge, generally, the NotifyJobStatus command reports the number of printed pages and the number of printed images. Accordingly, the above-described control makes it possible to obtain the (N+1)^{th} image before notification of completion of processing the N^{th} image (N is a natural number).

As a result, after receiving the image data of an image, it is possible to receive the image data of the next image without waiting for completion of checking, decoding, and writing to the second buffer 112 of the image data of the preceding image. Accordingly, processing waiting time, and thus, the entire processing time can be reduced, so that it is possible to reduce time for which the DSC 20 is bound to processing at the time of performing printing by direct printing.

Once the image processing module 102 transmits a processing progress notice in step S215, the image processing module 102 proceeds to processing the next image (steps S224 through S226) without confirming subsequent transmission of a NotifyJobStatus command. That is, the processing related to a processing progress notice is performed in such a manner as to interrupt the flow of the sequential operation of receiving, checking and decoding image data.

Next, in steps S227 through S233 of FIG. 6B, the communications control module 101 and the image processing module 102 repeat the operation from transmission of a GetPartialObject command up to writing to the second buffer 112 until decoding and writing to the second buffer 112 are completed with respect to all images (two images in this case) for one page. When the decoding and writing are completed, the image processing module 102 recognizes completion of writing image data for a single image, completion of writing image data for one page, and completion of writing all images.

Each of the following three operations is performed by the image processing module 102 when the image processing module 102 recognizes the occurrence of a corresponding situation. These operations may be performed in any order as long as a processing progress notice is transmitted prior to a processing completion notice.

As one of these operations, in step S234, in correspondence to completion of writing image data for a single image, the image processing module 102 transmits a processing progress notice to notify the communications control module 101 of the number of the page that is being processed and the number of written images. Then, in step S235, in response to this notice, the communications control module 101 transmits to the DSC 20 a NotifyJobStatus command to report the page number and the number of images. This operation is equal to that of steps S125 and S126 of FIG. 5 except that the number of written images is two.

Further, in step S236, in correspondence to completion of writing image data for one page to the second buffer 112, the image processing module 102 transmits an image rendering instruction to instruct the image rendering module 103 to execute printing for one page. Then, in steps S237 and S238, the image rendering module 103 performs printing for one page in response to this instruction as in steps S122 through S124 of FIG. 5.

Then, in step S239, in correspondence to completion of writing all images to the second buffer 112, the image processing module 102 transmits a processing completion notice to the communications control module 101. In step S240, in response to this notice, the communications control module 101 transmits a NotifyDeviceStatus command to the DSC 20. This operation is equal to that of steps S127 and S128 of FIG. 5.

In the case of printing a page formed of two images, the printer 10 operates as described above.

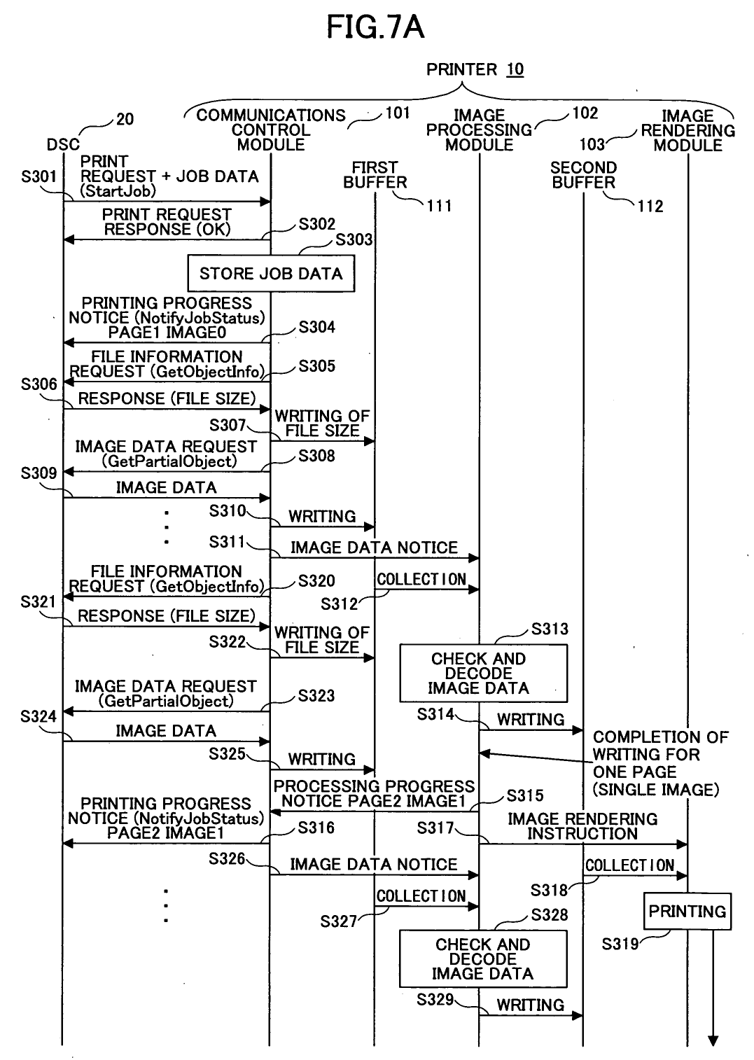

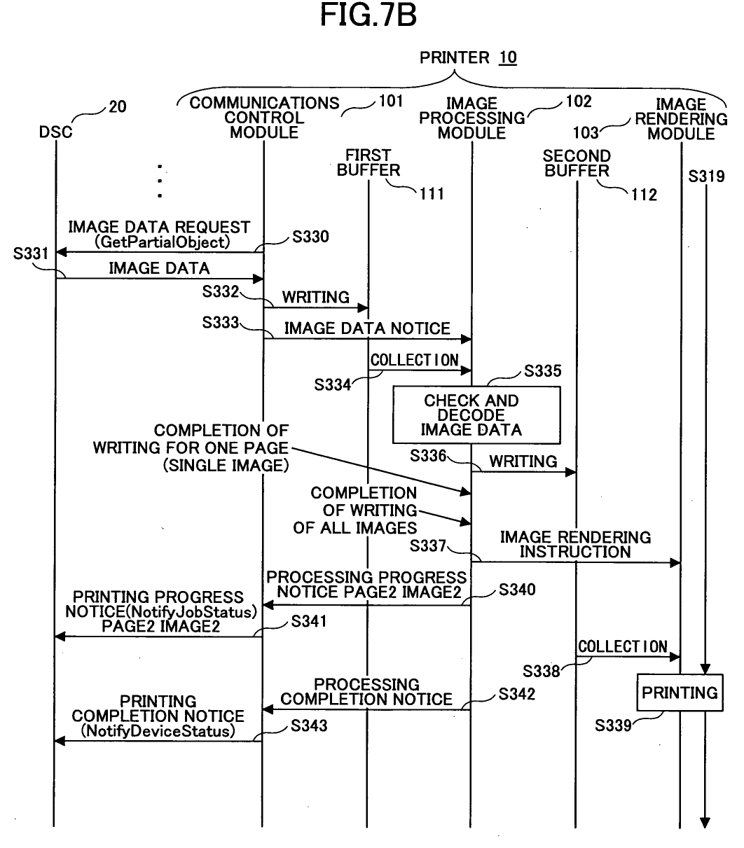

Next, FIGS. 7A and 7B show an operational sequence in the case of printing two pages each formed of a single image. In FIGS. 7A and 7B, a description of the same part as FIGS. 5, 6A, or 6B is simplified or omitted.

In this case, the operation from transmission of a StartJob command in step S301 up to storage of decoded image data by the printer 10 in step S314 is the same as that of steps S101 through S114 of FIG. 5. In this case also, since writing image data for a single image is completed in step S314, in step S315, the image processing module 102 transmits a processing progress notice to the communications control module 101. Here, writing image data for one page is also completed at the same time. Accordingly, the processing progress notice is to the effect that the next (second) page is being processed and the number of written images is one. Then, in step S316, in response to this notice, the communications control module 101 transmits to the DSC 20 a NotifyJobStatus command to report the page number and the number of images.

Further, since writing image data for one page is completed in step S314, in step S317, the image processing module 102 transmits an image rendering instruction to the image rendering module 103. Then, in steps S318 and S319, in response to this instruction, the image rendering module 103 collects image data and performs printing. This series of operations is equal to that of steps S122 through S124 of FIG. 5.

Compared with the operations of steps S122 through S126 of FIG. 5, the order of the processing progress notice and the image rendering instruction is reversed in the operations of steps S315 through S319 of FIG. 7A. However, as described above with reference to FIG. 5, either of the processing progress notice and the image rendering instruction may be transmitted first.

Further, in the operation of FIG. 7A, there still remains image data to be obtained from the DSC 20 even after the image data for one page is obtained. Accordingly, the communications control module 101 transmits a GetObjectInfo command to the DSC 20, and obtains the file size of an image file of which image data is to be obtained next. Then, the communications control module 101 writes the obtained file size to the first buffer 111. The communications control module 101 goes on to transmit a GetPartialObject command to the DSC 20, and obtains image data. The image processing module 102 processes image data newly written to the first buffer 111 (steps S320 through S329).

In this case, the operations of the communications control module 101 up to transmission of an image data notice (step S326) are usually performed in sequence irrespective of the progress of decoding in the image processing module 102, such as reception of a processing progress notice and transmission of a NotifyJobStatus command. Accordingly, before transmission of a NotifyJobStatus command to the effect that processing is completed with respect to a page, the image data of the image of the next page is obtained. On the other hand, in PictBridge, generally, the NotifyjobStatus command reports the number of printed pages and the number of printed images. The command transmitted in step S316 is different in page number from the command previously transmitted in step S304. Accordingly, the DSC 20 understands that the NotifyJobStatus command of step S316 is a notice to the effect that printing for one page is completed. Accordingly, the above-described control makes it possible to obtain the image of the (N+1)^{th} page before notification of completion of processing the N^{th} page (N is a natural number).

As a result, after receiving the image data of the image of a page, it is possible to receive the image data of the image of the next page without waiting for completion of checking and decoding of the image data of the image of the preceding page. Accordingly, processing waiting time, and thus, the entire processing time can be reduced, so that it is possible to reduce time for which the DSC 20 is bound to processing at the time of performing printing by direct printing.

Once the image processing module 102 transmits a processing progress notice in step S315 and an image rendering instruction in step S317, the image processing module 102 proceeds to processing the next image (steps S327 through S329) without confirming subsequent transmission of a NotifyJobStatus command or completion of printing. That is, the processing related to a processing progress notice and an image rendering instruction is performed in such a manner as to interrupt the flow of the sequential operation of receiving, checking and decoding image data.

Next, in steps S330 through S336 of FIG. 7B, the communications control module 101 and the image processing module 102 repeat the operation from transmission of a GetPartialObject command up to writing to the second buffer 112 until decoding and writing to the second buffer 112 are completed with respect to all the images (a single image in this case) of the next page. When the decoding and writing are completed, the image processing module 102 recognizes completion of writing image data for a single image, completion of writing image data for one page, and completion of writing all images.

The following operations performed in accordance with this recognition (steps S337 through S343) are the same as those of steps S234 through S240 of FIG. 6B. In the illustrated case, the image rendering instruction of step S337 is transmitted prior to the processing progress notice of step S340. However, as described above with reference to FIG. 6B, either of the image rendering instruction and the processing progress notice may be transmitted first.

Further, the image rendering module 103 may perform collection of image data and printing (steps S338 and S339) corresponding to the image rendering instruction for the second page not immediately after receiving the image rendering instruction but after completion of printing with respect to the page that has been in the process of printing.

In the case of printing two pages each formed of a single image, the printer 10 operates as described above.

Even in the case of printing three or more pages, a page including three or more images, or multiple pages each including multiple images, the communications control module 101 may sequentially transmit GetPartialObject commands to the DSC 20 and obtain image data (or transmit a GetObjectInfo command to the DSC 20 image file by image file and obtain file size information) until completion of obtaining the image data of one or more images for all pages in the same manner as in the case of each of the above-described operations. When the image processing module 102 finishes writing image data for a single image to the second buffer 112, the image processing module 102 may transmit a processing progress notice to the communications control module 101. When the image processing module 102 finishes writing image data for one page to the second buffer 112, the image processing module 102 may transmit an image rendering instruction to the image rendering module 103. When the image processing module 102 finishes writing image data for all pages to the second buffer 112, the image processing module 102 may transmit a processing completion notice to the communications control module 101. This can produce the same effects as the operations as described above with reference to FIGS. 5 through 7B.

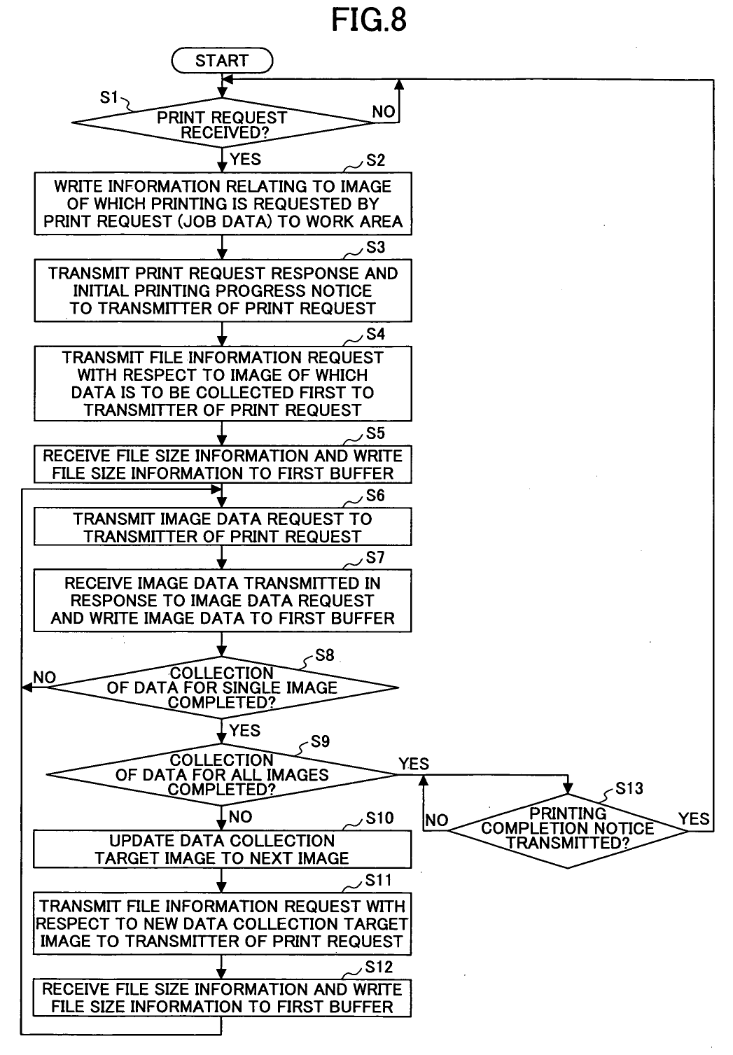

Next, the flowcharts of operations performed by the above-described modules 101 through 103 in the printer 10 are shown in FIGS. 8 through 11. The CPU 11 of the printer 10 executes the programs related to the modules 101 through 103 shown in FIG. 4 at the time of starting the printer 10, thereby starting the operations shown in the flowcharts. The CPU 11 continues the operations until the printer 10 is turned off.

FIG. 8 is a flowchart showing an operation relating to the communications control module 101.

In this operation, first, in step S1, the CPU 11 waits until receiving a print request (specifically, a StartJob command). If the CPU 11 determines that the CPU 11 has received a print request (YES in step S1), in step S2, the CPU 11 writes information relating to an image of which printing is requested by the print request (that is, job data indicating the name and the ID of image data) to a work area. Thereafter, in step S3, the CPU 11 transmits a print request response and an initial printing progress notice (specifically, a NotifyJobStatus command of “Page1 Image0”) to the transmitter of the print request.

Then, in step S4, the CPU 11 transmits a file information request (specifically, a GetObjectInfo command) to the transmitter of the print request, specifying the ID of an image file with respect to an image of which data is to be collected first. Thereafter, in step S5, the CPU 11 receives file size information transmitted in response to the file information request, and writes the received file size information to the first buffer 111. The file size information may contain information other than a file size.

Next, in step S6, the CPU 11 transmits an image data request (specifically, a GetPartialObject command) to the transmitter of the print request. Then, in step S7, the CPU 11 receives image data transmitted in response to this request, and writes the received image data to the first buffer 111. These operations of step S7 correspond to the operations of an obtaining step and a storage step, and in these operations, the CPU 11 functions as an obtaining part and a storage part.

Thereafter, in step S8, the CPU 11 determines whether collection of image data for a single image is completed. If collection of image data for a single image is completed (YES in step S8), in step S9, the CPU 11 further determines whether collection of image data for all images is completed. If collection of image data for all images is not completed (NO in step S9), in step S10, the CPU 11 updates the image of which data is to be collected (data collection target image) to the next image. Then, in step S11, the CPU 11 transmits a file information request for the new data collection target image to the transmitter of the print request. In step S12, the CPU 11 receives file size information transmitted in response to the file information request, and writes the received file size information to the first buffer 111. The file size information may contain information other than a file size. Then, the CPU 11 directly returns to step S6, and repeats the operation.

On the other hand, if collection of image data for a single image is not completed (NO in step S8), the CPU 11 directly returns to step S6, and repeats the operation.

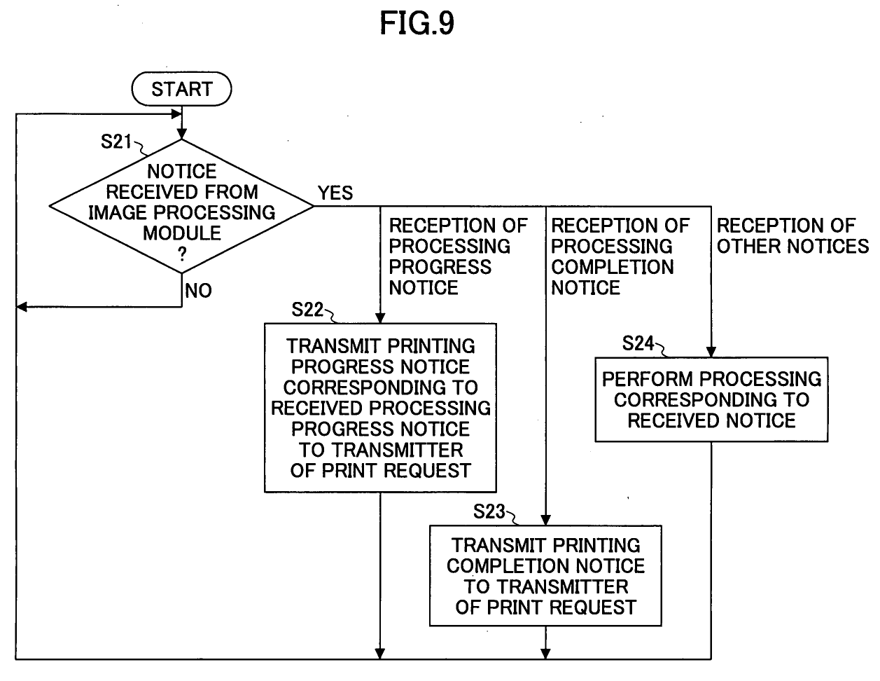

Further, if collection of image data for all images is completed (YES in step S9), in step S13, the CPU 11 waits until transmitting a printing completion notice, and thereafter, returns to step S1 to repeat the operation. That is, the CPU 11 waits until receiving another print request, and when the CPU 11 receives another print request, the CPU 11 repeats the operations of and after step S2. The printing completion notice is transmitted in the operation shown next in FIG. 9.

FIG. 9 is a flowchart showing another operation relating to the communications control module 101. The CPU 11 may be caused to execute the operation of FIG. 8 and the operation of FIG. 9 in separate threads.

In the operation shown in FIG. 9, the CPU 11 waits until receiving a notice from the image processing module 102 in step S21. If the CPU 11 determines that the CPU 11 has received a notice from the image processing module 102 (YES in step S21), the CPU 11 performs the operation of step S22, S23, or S24 in accordance with the contents of the notice.

That is, if the CPU 11 receives a processing progress notice, in step S22, the CPU 11 transmits a printing progress notice (specifically, a NotifyJobStatus command) indicating a page number and the number of images corresponding to the received notice to the transmitter of a print request. If the CPU 11 receives a processing completion notice, in step S23, the CPU 11 transmits a printing completion notice (specifically, a NotifyDeviceStatus command) to the transmitter of the print request.

When the CPU 11 detects reception of a print request in step S1 of FIG. 8, the CPU 11 can determine where the CPU 11 has received the print request from. Further, the processing progress notice and the processing completion notice are transmitted from the image processing module 102 in accordance with the progress of processing image data. Accordingly, in the case of receiving these notices, there must be a corresponding print request if the operation is normal. Therefore, these notices are transmitted to its transmitter (from which image data is obtained).

The operations of steps S22 and S23 correspond to the operation of a notification step, and in this operation, the CPU 11 functions as a notification part.

Further, if the CPU 11 receives a notice other than those described above, in step S24, the CPU 11 performs processing corresponding to the received notice. After completion of processing in any of steps S22 through S24, the CPU 11 returns to step S21, and waits until receiving another notice from the image processing module 102.

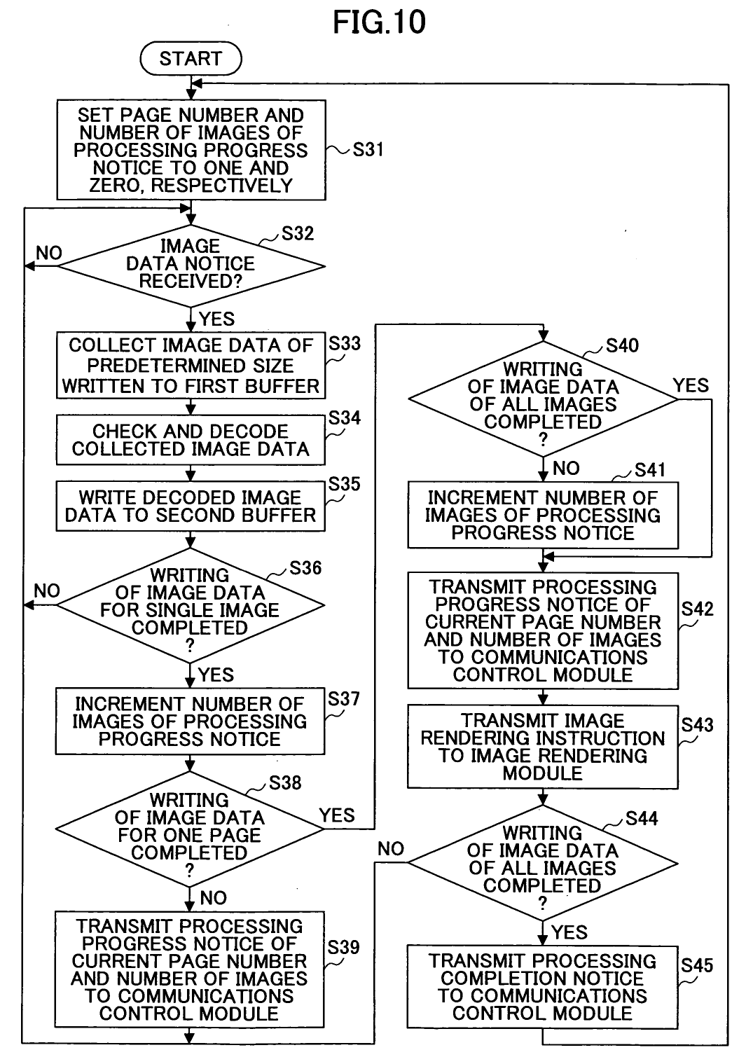

Next, FIG. 10 is a flowchart showing an operation relating to the image processing module 102.

In this operation, first, in step S31, the CPU 11 sets the page number and the number of images of a processing progress notice to one and zero, respectively. In step S32, the CPU 11 waits to receive an image data notice from the communications control module 101. This is because not reception of image data from the DSC 20 but a notice from the communications control module 101 acts as a trigger to cause the image processing module 102 to start image processing.

When the CPU 11 receives an image data notice, in step S33, the CPU 11 collects image data of a predetermined size written to the first buffer 111. In step S34, the CPU 11 checks and decodes the collected image data, and in step S35, writes the decoded image data to the second buffer 112. The details of these operations are as described with respect to steps S12 through S114 of FIG. 5. Further, these operations correspond to the operation of a processing step, and in this operation, the CPU 11 functions as a processing part.

After step S35, in step S36, the CPU 11 determines whether writing of image data for a single image to the second buffer 112 is completed, and if the writing is not completed (NO in step S36), the CPU 11 returns to step S32 and repeats the operation.

On the other hand, if the writing is completed in step S36, in step S37, the CPU 11 increments the number of images of the processing progress notice by one, and proceeds to step S38. If the CPU 11 determines in step S38 that writing image data for one page to the second buffer 112 is not completed (NO in step S38), in step S39, the CPU 11 transmits to the communications control module 101 a processing progress notice indicating the current page number and number of images. Thereafter, the CPU returns to step S32 and repeats the operation.

Further, if writing image data for one page is completed in step S38 (YES in step S38), the CPU 11 proceeds to step S40. In step S40, the CPU 11 determines whether writing the image data of all images to the second buffer 112 is completed. If the writing is not completed (NO in step S40), in step S41, the CPU 11 increments the page number of the processing progress notice. Thereafter, in step S42, the CPU 11 transmits to the communications control module 101 a processing progress notice indicating the current page number and number of images. If writing the image data of all images is completed in step S40 (YES in step S40), in step S42, the CPU 11 transmits a processing progress notice to the communications control module 101 without incrementing the page number.

This is because, as described above, the page number added to the processing progress notice is the number of a page that is being processed, and if the page number is incremented even when processing of all images is completed, the number of a page subsequent to the last page, which actually does not exist, is indicated, thus causing a problem.

The processing progress notices in steps S39 and S42, which are internal notices transmitted inside the printer 10, may be different in format from the printing progress notice that the communications control module 101 transmits to the DSC 20.

Further, after step S42, in step S43, the CPU 11 transmits an image rendering instruction to the image rendering module 103.

Further, in step S44, the CPU 11 determines whether writing of the image data of all images to the second buffer 112 is completed. If the writing is not completed (NO in step S44), the CPU 11 returns to step S32 and repeats the operation. If the writing is completed (YES in step S44), in step S45, the CPU 11 transmits a processing completion notice to the communications control module 101, and returns to step S31 to repeat the operation. In this case, image data to be processed in response to the next image data notice to be received is considered as data relating to a new print job. Accordingly, in step S31, the CPU 11 resets the page number and the number of images of the processing progress notice.

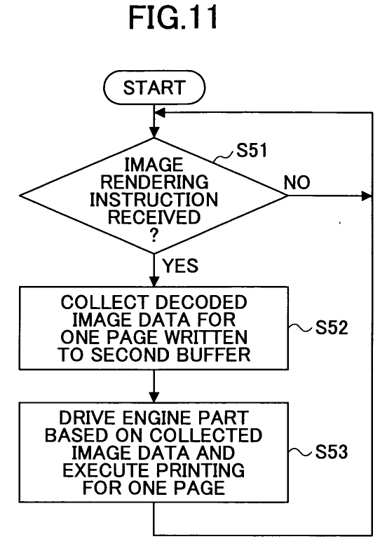

Next, FIG. 11 is a flowchart showing an operation relating to the image rendering module 103.

In this operation, first, in step S51, the CPU 11 waits to receive an image rendering instruction from the image processing module 102. This is because not reception of image data from the DSC 20 but an instruction from the image processing module 102 acts as a trigger to cause the image rendering module 103 to start printing.

When the CPU 11 receives an image rendering instruction, in step S52, the CPU 11 collects image data of a predetermined size written to the second buffer 112. In step S53, the CPU 11 drives the engine part 16 based on the collected image data, and causes the engine part 16 to execute printing for one page. When the printing for one page is completed, the CPU 11 returns to step S51 to repeat the operation, and waits for the next image rendering instruction. These operations correspond to the operation of a printing step, and in this operation, the CPU 11 functions as a print part.

By causing the CPU 11 to execute the operations as described above, it is possible to cause the printer 10 to realize the operations related to the modules 101 through 103 as described above with reference to FIGS. 5 through 7B. This makes it possible to produce the effect, described in the explanation of these drawings, that the time for which an apparatus on the image feeding side is bound to processing at the time of performing printing by direct printing can be reduced. However, in FIGS. 5 through 7B, some operations may be shown interchanged in their order of execution in some parts that require no timing management. Accordingly, strictly speaking, the operations of FIGS. 5 through 7B may not correspond to the operations shown in the flowcharts of FIGS. 8 thorough 11 in some parts.

According to this embodiment, software configuration, a communications protocol to be used, a data format, and the contents of processing are not limited to those described above in this embodiment. For example, the communications control module 101 does not always have to obtain image data successively. For example, the operations as shown in the flowcharts of FIGS. 8 through 11 do not have to be executed constantly. These operations may be event-driven-type operations whose execution is started in response to reception of a request or instruction. Further, the operation shown in FIG. 9 may be an interrupt operation triggered by reception of a notice from the image processing module 102 so as to interrupt the operation shown in FIG. 8.

According to one aspect of the present invention, processing time in the case of performing direct printing by connecting an image source device supporting direct printing or PictBridge to a laser printer having an electrophotographic print engine is reduced. Accordingly, the present invention is suitable for laser printers, while the present invention may be applied to any printers that support direct printing or PictBridge. Accordingly, the present invention may also be applied to inkjet printers, dot impact printers, and printers that form images by other methods.

The program according to one embodiment of the present invention is for causing a computer to control a printer, thereby realizing such functions as those of the printer 10 described above. By causing a computer to execute such a program, it is possible to produce the above-described effects.

Such a program may be stored from the beginning in a storage part provided in a computer, such as a ROM or HDD. Alternatively, such a program may be provided, being recorded on recording media such as a CD-ROM and a flexible disk or nonvolatile recording media (memories) such as an SRAM, an EEPROM, and a memory card. It is possible to cause a CPU to execute the above-described steps by installing the program recorded on the medium (memory) in a computer and causing the CPU to execute the program, or by causing the CPU to read out the program from the memory and execute the program.

Further, it is also possible to download a program from an external apparatus connected to a network and having a recording medium on which the program is recorded or an external apparatus connected to a network and storing the program in a storage part, and to have the program executed.

As described above, according to a printer, a method of controlling the printer, and a recording medium on which recorded is a program for causing a computer to execute the method according to one embodiment of the present invention, it is possible to reduce time for which an apparatus on the image feeding side is bound to processing at the time of performing printing by direct printing.

Accordingly, by using the present invention, it is possible to configure a printer capable of performing direct printing in a short period of time.

The present invention is not limited to the specifically disclosed embodiment, and variations and modifications may be made without departing from the scope of the present invention.

The present application is based on Japanese Priority Patent Application No. 2005-007521, filed on Jan. 14, 2005, the entire contents of which are hereby incorporated by reference.

1. A printer supporting direct printing, comprising:
an obtaining part configured to obtain images from an external image feeder; and
a notification part configured to notify the external image feeder of completion of processing the images obtained by the obtaining part,
wherein the obtaining part is capable of obtaining an (N+1)^{th} one of the images before the notification part notifies the external image feeder of completion of processing an N^{th} one of the images, N being a natural number.

2. A printer supporting direct printing, comprising:
an obtaining part configured to obtain images from an external image feeder; and
a notification part configured to notify the external image feeder of completion of processing pages including the images obtained by the obtaining part,
wherein the obtaining part is capable of obtaining at least one of the images corresponding to an (N+1)^{th} one of the pages before the notification part notifies the external image feeder of completion of processing an N^{th} one of the pages, N being a natural number.

3. A printer supporting direct printing, comprising:
a notification part configured to notify a feeder of an image to be printed of completion of printing all pages,
wherein the notification part is capable of notifying the feeder of the completion of printing all the pages before the completion of printing all the pages.

4. A printer supporting direct printing, comprising:
a notification part configured to notify a feeder of obtained images of progress of printing with respect to the images or a page including at least two of the images,
wherein the notification part is capable of notifying the feeder of completion of printing with respect to one of the images or the page before completion of printing the one of the images or the page.

5. A printer supporting direct printing, comprising:
an obtaining part configured to obtain images from an external image feeder and store image data of the images in a buffer; and
a processing part configured to process the image data stored in the buffer,
wherein the obtaining part is capable of obtaining the image data of an (N+1)^{th} one of the images before the processing part finishes processing the image data of an N^{th} one of the images after the obtaining part stores the image data of the N^{th} one of the images in the buffer, N being a natural number.

6. The printer as claimed in claim 5, further comprising:
a print part configured to print the images, wherein:
the processing part process the image data stored in the buffer and stores the processed image data in an additional buffer;
the print part prints the images based on the image data stored in the additional buffer; and
the processing part is capable of processing the image data of the (N+1)^{th} one of the images before the print part finishes printing with respect to the N^{th} one of the images after the processing part stores the processed image data in the additional buffer with respect to the N^{th} one of the images.

7. The printer as claimed in claim 6, wherein the obtaining part, the processing part, and the print part are configured as independent modules.

8. A printer supporting direct printing, comprising:
a processing part configured to process image data stored in a first buffer and store the processed image data in a second buffer; and
a print part configured to print images based on the image data stored in the second buffer,
wherein the processing part is capable of processing the image data of an (N+1)^{th} one of the images before the print part finishes printing with respect to an N^{th} one of the images after the processing part stores the processed image data in the second buffer with respect to the N^{th} one of the images, N being a natural number.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)
